(19) United States
(12) Patent Application Publication
(10) Pub. No.: US 2022/0032679 A1
(43) Pub. Date: Feb. 3, 2022

(54) COLLAPSIBLE ARTISTIC SCULPTURE AND METHOD OF MAKING SAME

(71) Applicant: Wen Jennifer Ma, New York, NY (US)

(72) Inventor: Wen Jennifer Ma, New York, NY (US)

(21) Appl. No.: 16/942,910

(22) Filed: Jul. 30, 2020

(51) Int. Cl. B44C 3/12; B32B 3/30; B32B 7/09; B32B 7/14; B32B 37/12

(52) U.S. Cl. CPC B44C 3/12; B32B 3/30; B32B 2451/00; B32B 7/14; B32B 37/1292; B32B 7/09

(57) ABSTRACT

Disclosed is a method of making an extensible sculpture including providing a plurality of flexible material sheets; cutting each of the plurality of flexible material sheets to form a plurality of at least three sculptural pieces; arranging the sculptural pieces in a predetermined order; defining a first set of connection columns on the top face of the first sculptural piece; using a first connector to fixedly connect the bottom face of the second sculptural piece to the top face of the first sculptural piece at the first set of connection columns; defining a second set of connection columns on the top face of the second sculptural piece; and using a second connector to fixedly connect the bottom face of the third sculptural piece to the top face of the second sculptural piece at the second set of connection columns.

### FIELD

The present disclosure is generally related to an artistic sculpture and a method for making an artistic sculpture, more particularly, this disclosure is related to apparatuses and methods of making an extensible sculpture from a plurality of flexible material sheets.

### BACKGROUND

Extensible sculptures have a variety of uses including, but not limited to aesthetic sculptures such as artistic sculptures.

It remains desirable to develop extensible sculptures that are cheaper to manufacture, simpler to manufacture, quicker to manufacture, less prone to important quality problems during manufacture, or some combination thereof.

Accordingly, those skilled in the art continue with research and development efforts directed to extensible sculptures.

### SUMMARY

Disclosed is a method of making an extensible sculpture. In one aspect the method comprises providing a plurality of flexible material sheets; cutting each of the plurality of flexible material sheets to form a plurality of at least three sculptural pieces wherein each of the sculptural pieces has a top face and a bottom face opposite the top face; arranging the sculptural pieces in a predetermined order to define at least a first sculptural piece, a second sculptural piece, and a third sculptural piece; defining a first set of connection columns on the top face of the first sculptural piece, each of the connection columns of the first set of connection columns being elongated and each being offset from one another; using a first connector to fixedly connect the bottom face of the second sculptural piece to the top face of the first sculptural piece at the first set of connection columns; defining a second set of connection columns on the top face of the second sculptural piece, each of the connection columns of the second set of connection columns being elongated and each being offset from one another and each being offset from each of the connection columns of the first set of connection columns; and using a second connector to fixedly connect the bottom face of the third sculptural piece to the top face of the second sculptural piece at the second set of connection columns.

Also disclosed is an extensible sculpture. In one aspect, the extensible sculpture comprises a plurality of a number N of sculptural pieces where the number N is at least 4; where each of the sculptural pieces has a top face and a bottom face opposite the top face; where the plurality of sculptural pieces are arranged in a predetermined order from a first sculptural piece, to a second sculptural piece, to at least one intermediate sculptural piece, to a last sculptural piece; wherein the top face of the first sculptural piece comprises a first set of connection columns with each of the connection columns of the first set of connection columns being elongated and each being offset from one another. In this latter aspect the extensible sculpture further comprises a first connector fixedly connecting the bottom face of the second sculptural piece to the top face of the first sculptural piece at the first set of connection columns; wherein the top face of the second sculptural piece comprises a second set of connection columns with each of the connection columns of the second set of connection columns being elongated, being offset from one another, and being offset from each of the connection columns of the first set of connection columns; and a second connector fixedly connecting the bottom face of the at least one intermediate sculptural piece to the top face of the second sculptural piece at the second set of connection columns.

Also disclosed is a method of making an extensible sculpture. In certain aspects the method includes providing a plurality M of flexible material sheets; cutting each of the plurality of flexible material sheets to form a plurality N of sculptural pieces where N is greater than M and where N is at least 3, wherein each of the sculptural pieces has a top face and a bottom face opposite the top face; arranging the sculptural pieces in a predetermined order to define at least a first sculptural piece, a second sculptural piece, and a third sculptural piece; defining a first set of connection columns on the top face of the first sculptural piece, each of the connection columns of the first set of connection columns being elongated, each being offset from one another, and each being within 5 degrees of parallel to each other; using an adhesive to fixedly connect the bottom face of the second sculptural piece to the top face of the first sculptural piece at the first set of connection columns; defining a second set of connection columns on the top face of the second sculptural piece, each of the connection columns of the second set of connection columns being elongated, each being offset from one another, each being offset from each of the connection columns of the first set of connection columns, and each being within 5 degrees of parallel to each other; and using the adhesive to fixedly connect the bottom face of the third sculptural piece to the top face of the second sculptural piece at the second set of connection columns.

Other aspects of the disclosed extensible sculpture and method of making an extensible sculpture will become apparent from the following detailed description, the accompanying drawings and the appended claims.

### BRIEF DESCRIPTION OF THE DRAWINGS

FIG. 1 is a view of a first aspect of a flexible material sheet.

FIG. 2 is a view of a first aspect of a first sculptural piece, a second sculptural piece, and a third sculptural piece.

FIG. 3 is a close up view of a second aspect of a first sculptural piece with a first set of connection columns.

FIG. 4 is a close up view of the second aspect of a first sculptural piece with a second aspect of a second sculptural piece overlaid thereon.

FIG. 5 is a close up view of a first sculptural piece with a second aspect of a second sculptural piece overlaid thereon and a third sculptural piece overlaid over the second sculptural piece.

FIG. 6 is a view of a plurality of sculptural pieces being stacked in a predetermined order.

FIG. 7 is a view of a plurality of sculptural pieces stacked in a predetermined order to form a first aspect of an extensible sculpture in a closed configuration.

FIG. 8 is a bottom view of the first aspect of an extensible sculpture in an opened configuration.

FIG. 9 is a first top view of the first aspect of an extensible sculpture in an opened configuration.

FIG. 10 is another top view of the first aspect of an extensible sculpture in another opened configuration.

FIG. 11 is another top view of the first aspect of an extensible sculpture in another opened configuration.

### DETAILED DESCRIPTION

The following detailed description refers to the accompanying drawings, which illustrate specific embodiments and/or aspects described by the disclosure. Other embodiments and/or aspects having different structures and operations do not depart from the scope of the present disclosure. Like reference numerals may refer to the same feature, element or component in the different drawings.

Illustrative, non-exhaustive embodiments, which may be, but are not necessarily, claimed, of the subject matter according to the present disclosure are provided below.

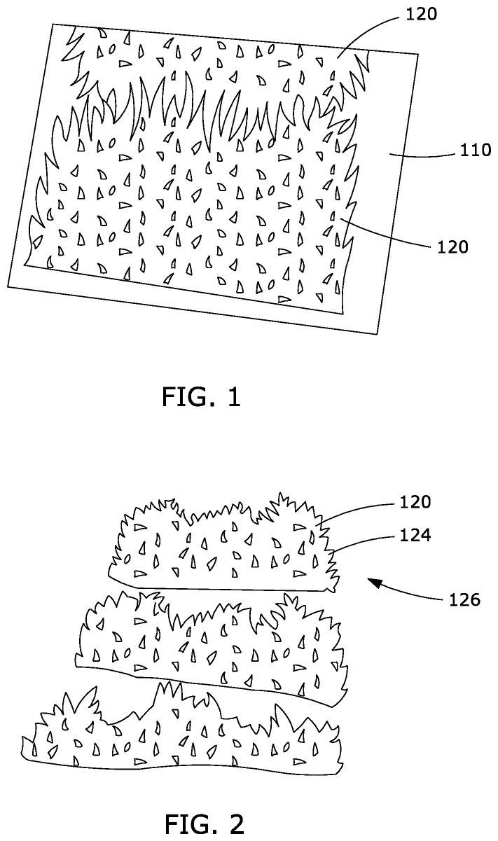

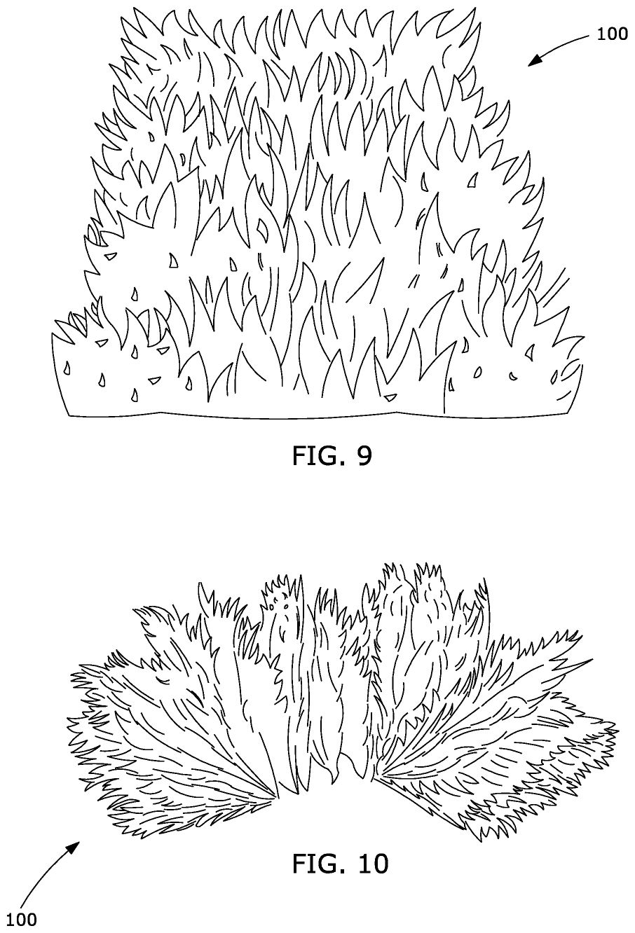

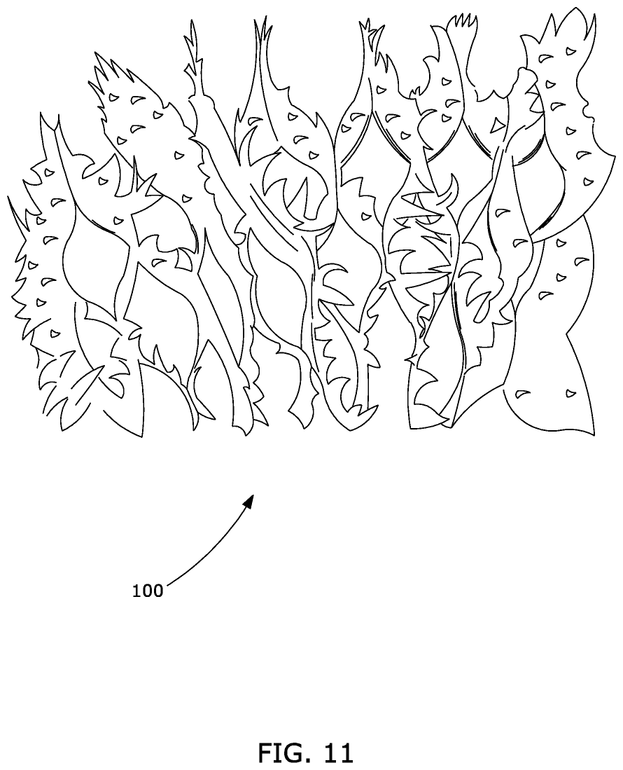

Referring to FIGS. 1, 2 and 9-11, in some aspects the disclosed extensible sculpture 100 includes a sculptural piece 120 that may be cut from a flexible material sheet 110. In some aspects a flexible material sheet 110 comprises paper, cloth, a polymer sheet, metal foil, or some combination thereof. In the aspect shown in FIG. 1, a single flexible material sheet 110 may be cut to form more than one sculptural piece 120. This latter example is not limiting and it is also contemplated that a flexible material sheet 110 may be cut to form a single sculptural piece 120 or more than two sculptural pieces 120. Generally, a single flexible material sheet 110 may be cut to form 1 sculptural piece 120, or 2 sculptural pieces, or 3 sculptural pieces, or some plural number N sculptural pieces, where N is an integer greater than 1. In some aspects, N will be greater than 4. In some aspects, N will be 10 or greater.

In general, a plural number M of flexible material sheets 110 may be provided and these same M flexible material sheets 110 may be cut to form a plural number N of sculptural pieces 120 where N is at least 3 and where N is equal to or greater than M.

The operation to cut a sculptural piece 120 from a flexible material sheet 110 may be performed with a knife, a razor, scissors, or other blade. In some aspects, the operation to cut a sculptural piece 120 from a flexible material sheet 110 may be performed by die cutting or laser cutting. The cutting may be a manual process, an automated process, or a combination thereof.

Referring now to FIGS. 2 and 8, in some aspects each sculptural piece 120 has a top face 124 and a bottom face 126 opposite the top face 124. A sculptural piece 120 will have some thickness separating the top face 124 from the bottom face 126, but in some aspects this thickness may be very small. In some non-limiting aspects, the thickness of a sculptural piece 120 is less than 5 mm, less than 1 mm, or less than 0.5 mm, or less than 0.2 mm.

Referring to FIGS. 2-6, in some aspects the disclosed extensible sculpture 100 is assembled from a plurality of N number of sculptural pieces 120. In this latter aspect, the sculptural pieces 120 are arranged in a predetermined order from a first sculptural piece 131, to a second sculptural piece 141, to one or more optional intermediate sculptural pieces 151, to a last sculptural piece 171. In this latter aspect, the second sculptural piece 141 is an intermediate sculptural piece 151. In this latter aspect, there is a third sculptural piece 161 that is also an intermediate sculptural piece 151. In this latter aspect, the top face 132 of the first sculptural piece 131 comprises a first set 134 of connection columns 135, 136, 137 with each of the connection columns 135, 136, 137 of the first set 134 of connection columns being elongated and each being offset from one another.

The connection columns of the first set 134 of connection columns, or any other set of connection columns, may be substantially parallel to one another. As used herein “substantially parallel” to one another means that the columns are within 10 degrees of parallel to each other. Columns that are “substantially parallel” to one another may also be within 5 degrees of parallel to each other, or within 1 degree of parallel to one another.

With continued reference to FIGS. 2-6, in this latter aspect these connection columns 135, 136, 137 each comprise a connector. Here, and in general throughout this disclosure unless otherwise noted, a connector may be an adhesive, or an adhesive strip or tape, or stitching, or mechanical fastener, such as, but without limitation, a grommet. The connector on the first sculptural piece 131 may be referred to herein as the first connector 138. In the aspect shown, the first connector 138 is an adhesive strip.

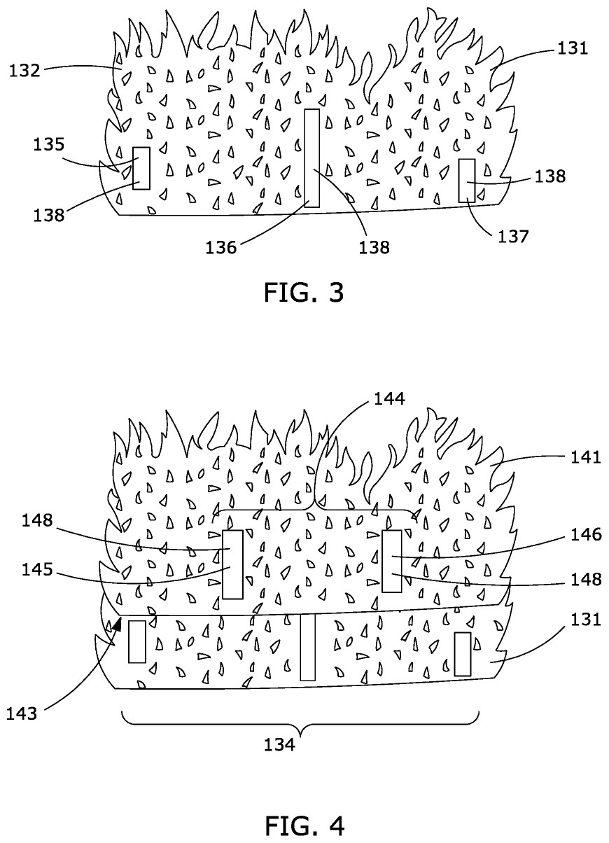

With continued reference to FIGS. 3-6, in the latter aspect the first connector 138 is used to fixedly connect the bottom face 143 of the second sculptural piece 141 to the top face 132 of the first sculptural piece 131 at the first set 134 of connection columns 135, 136, 137.

With continued reference to FIGS. 3-6, in the latter aspect the second sculptural piece 141 is assembled and used in a fashion similar to that of the first sculptural piece 131. The top face 142 of the second sculptural piece 141 comprises a second set 144 of connection columns 145, 146. Each of the connection columns 145, 146 of the second set 144 of connection columns 145, 146 is elongated and is offset from one another. As assembled in the latter aspect of the extensible sculpture 100, each of the connection columns 145, 146 of the second set 144 of connection columns 145, 146 is offset from each of the connection columns 135, 136, 137 of the first set 134 of connection columns 135, 136, 137. In this latter aspect, the second set 144 of connection columns 145, 146 comprises a second connector 148. In the aspect shown, the second connector 148 is an adhesive strip. In other aspects the second connector 148 may be an adhesive, or stitching, or mechanical fastener.

It should be understood that the current subject matter covers both aspects where the connector on any given sculptural piece is the same as that on another sculptural piece, as well as aspects where the connector on any given sculptural piece differs from that on another sculptural piece. In the non-limiting aspect shown in FIGS. 3-5, the first connector 138 is the same as the second connector 148. In other aspects, the first connector 138 differs from the second connector 148. Similarly, the first connector 138 may be the same as the connector on any other sculptural piece 120.

With continued reference to FIGS. 4-6, in the latter aspect the second connector 148 is used to fixedly connect the bottom face 163 of the third sculptural piece 161 to the top face 142 of the second sculptural piece 141 at the second set 144 of connection columns 145, 146.

With continued reference to FIGS. 3-6, in the latter aspect the third sculptural piece 161 is assembled and used in a fashion similar to that of the first sculptural piece 131 and the second sculptural piece 141. The top face 162 of the third sculptural piece 161 comprises a third set 164 of connection columns 165, 166, 167. Each of the connection columns 165, 166, 167 of the third set 164 of connection columns 165, 166, 167 is elongated and is offset from one another. As assembled in the latter aspect of the extensible sculpture 100, each of the connection columns 165, 166, 167 of the third set 164 of connection columns 165, 166, 167 is offset from each of the connection columns 145, 146 of the second set 144 of connection columns 145, 146. As assembled in the latter aspect of the extensible sculpture 100, each of the connection columns 165, 166, 167 of the third set 164 of connection columns 165, 166, 167 is aligned with a corresponding connection column 135, 136, 137 of the first set 134 of connection columns 135, 136, 137, although this is merely exemplary of one optional aspect and is not limiting.

In some aspects, assembly of the extensible sculpture 100 continues in the fashion described above until each of the desired sculptural pieces 120 after the first sculptural piece 131 has been fixedly connected to the prior sculptural pieces 120.

In a sculpture consisting of an arbitrary number N of sculptural pieces 120, where N is 3 or greater, each of the sculptural pieces 120 may be referred to by a number from 1 to N, such that there is the first (1st) sculptural piece 131 and the last (Nth) sculptural piece 171 an at least one intermediate (N−1th)sculptural piece 151. In aspects with a plurality of intermediate sculptural pieces 151, there are N−2 intermediate pieces 151 which may be numbered from 2 to N−1. Each intermediate sculptural piece 151 is fixedly connected to exactly two other sculptural pieces 120 with the 2nd piece fixedly connected to the 1st and 3rd sculptural pieces 120; and generally for each intermediate sculptural piece 151 the N−1th sculptural piece 151 is fixedly connected to the N−2th and Nth sculptural pieces 120.

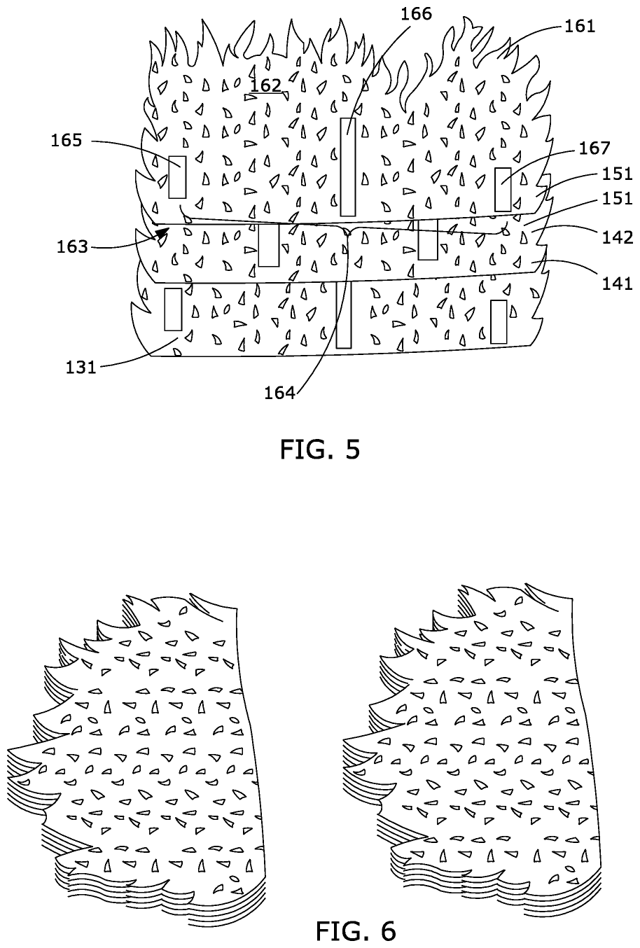

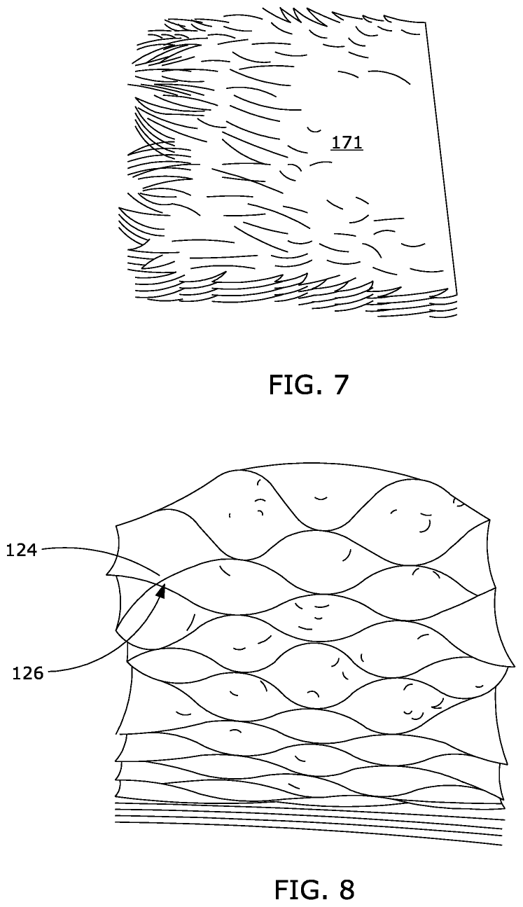

Referring now to FIGS. 1-6, it can be seen that in some aspects one or more of the sculptural pieces 120 differ from one or more other sculptural pieces 120 in shape, thickness, material, or some combination thereof. In the non limiting aspect shown, the first sculptural piece 131 differs from the second sculptural piece 141. With particular reference to FIGS. 3 and 4, it should be understood that the shape of the first sculptural piece 131 differs from the shape of the second sculptural piece 141. It should also be understood that this latter difference is non-limiting and that there are also acceptable aspects where the first sculptural piece 131 is substantially the same in shape, thickness, material, etc. as the second sculptural piece 141. Similarly, in the non limiting aspect shown, the first sculptural piece 131 differs from the third sculptural piece 161. With particular reference to FIGS. 3 and 5, it should be understood that the shape of the first sculptural piece 131 differs from the shape of the third sculptural piece 161. Again, it should also be understood that this latter difference is non-limiting and that there are also acceptable aspects where any given sculptural piece 120 is substantially the same in shape, thickness, material, etc. as one or more other sculptural pieces 120.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

As used herein, the terms “approximately” and “about” represent an amount close to the stated amount that still performs the desired function or achieves the desired result. For example, the terms “approximately” and “about” may refer to an amount that is within less than 10% of, within less than 5% of, within less than 1% of, within less than 0.1% of, and within less than 0.01% of the stated amount.

Although various embodiments of the disclosed apparatus, systems and methods have been shown and described, modifications may occur to those skilled in the art upon reading the specification. The present application includes such modifications and is limited only by the scope of the claims.

What is claimed is:

1. A method of making an extensible sculpture comprising:
providing a plurality of flexible material sheets;
cutting each of the plurality of flexible material sheets to form a plurality of at least three sculptural pieces wherein each of the sculptural pieces has a top face and a bottom face opposite the top face;
arranging the sculptural pieces in a predetermined order to define at least a first sculptural piece, a second sculptural piece, and a third sculptural piece;
defining a first set of connection columns on the top face of the first sculptural piece, each of the connection columns of the first set of connection columns being elongated and each being offset from one another;
using a first connector to fixedly connect the bottom face of the second sculptural piece to the top face of the first sculptural piece at the first set of connection columns;
defining a second set of connection columns on the top face of the second sculptural piece, each of the connection columns of the second set of connection columns being elongated and each being offset from one another and each being offset from each of the connection columns of the first set of connection columns; and
using a second connector to fixedly connect the bottom face of the third sculptural piece to the top face of the second sculptural piece at the second set of connection columns.

2. The method of claim 1, wherein the first sculptural piece differs from the second sculptural piece.

3. The method of claim 1, wherein the first sculptural piece differs from the third sculptural piece.

4. The method of claim 1, wherein the first connector comprises an adhesive or an adhesive strip or tape, or stitching, or mechanical fastener.

5. The method of claim 1, wherein the second connector comprises an adhesive or an adhesive strip or tape, or stitching, or mechanical fastener.

6. The method of claim 1, wherein the first connector is the same as the second connector.

7. The method of claim 1, wherein each of the connection columns of the first set of connection columns is within 5 degrees of parallel to each other.

8. The method of claim 1, wherein each of the connection columns of the second set of connection columns is within 5 degrees of parallel to each other.

9. The method of claim 8, wherein each of the connection columns of the second set of connection columns is within 5 degrees of parallel to each of the connection columns of the first set of connection columns.

10. The method of claim 1, wherein the plurality of at least three sculptural pieces comprises at least ten sculptural pieces.

11. The method of claim 1 wherein the cutting each of the plurality of flexible material sheets to form a plurality of sculptural pieces is performed using a computer program to draw out a design for each of the plurality of sculptural pieces.

12. The method of claim 1, further comprising cutting multiple sculptural pieces from a single flexible material sheet.

13. An extensible sculpture comprising:
a plurality of N sculptural pieces where N is at least 4;
wherein each of the sculptural pieces has a top face and a bottom face opposite the top face;
wherein the plurality of sculptural pieces are arranged in a predetermined order from a first sculptural piece, to a second sculptural piece, to at least one intermediate sculptural piece, to a last sculptural piece;
wherein the top face of the first sculptural piece comprises a first set of connection columns with each of the connection columns of the first set of connection columns being elongated and each being offset from one another;
a first connector fixedly connecting the bottom face of the second sculptural piece to the top face of the first sculptural piece at the first set of connection columns;
wherein the top face of the second sculptural piece comprises a second set of connection columns with each of the connection columns of the second set of connection columns being elongated, being offset from one another, and being offset from each of the connection columns of the first set of connection columns; and
a second connector fixedly connecting the bottom face of the at least one intermediate sculptural piece to the top face of the second sculptural piece at the second set of connection columns.

14. The extensible sculpture of claim 13, wherein N−2 of the sculptural pieces are fixedly connected to exactly two other sculptural pieces.

15. The extensible sculpture of claim 13, wherein the first sculptural piece differs from the second sculptural piece.

16. The extensible sculpture of claim 13, wherein the first connector comprises an adhesive or an adhesive strip or tape, or stitching, or mechanical fastener.

17. The extensible sculpture of claim 13, wherein the first connector is the same as the second connector.

18. The extensible sculpture of claim 13, wherein each of the connection columns of the first set of connection columns is within 5 degrees of parallel to each other.

19. The extensible sculpture of claim 13, wherein each of the connection columns of the second set of connection columns is within 5 degrees of parallel to each other.

20. A method of making an extensible sculpture comprising:
providing a plurality M of flexible material sheets;
cutting each of the plurality of flexible material sheets to form a plurality N of sculptural pieces where N is greater than M and where N is at least 3;
wherein each of the sculptural pieces has a top face and a bottom face opposite the top face;
arranging the sculptural pieces in a predetermined order to define at least a first sculptural piece, a second sculptural piece, and a third sculptural piece;
defining a first set of connection columns on the top face of the first sculptural piece, each of the connection columns of the first set of connection columns being elongated, each being offset from one another, and each being within 5 degrees of parallel to each other;
using an adhesive to fixedly connect the bottom face of the second sculptural piece to the top face of the first sculptural piece at the first set of connection columns;
defining a second set of connection columns on the top face of the second sculptural piece, each of the connection columns of the second set of connection columns being elongated, each being offset from one another, each being offset from each of the connection columns of the first set of connection columns, and each being within 5 degrees of parallel to each other; and
using the adhesive to fixedly connect the bottom face of the third sculptural piece to the top face of the second sculptural piece at the second set of connection columns.
